(19) United States
(12) Patent Application Publication
(10) Pub. No.: US 2007/0296888 A1
(43) Pub. Date: Dec. 27, 2007

(54) Backlight unit and liquid crystal display using the same

(75) Inventors: Gi Bin Kim, Anyang-si (KR); Tae Woo Kim, Yongin-si (KR); Sang Rae Lee, Gyeongju-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/646,708

(22) Filed: Dec. 27, 2006

(30) Foreign Application Priority Data
Jun. 22, 2006 (KR) P06-0056493

(51) Int. Cl. G02F 1/1335

(52) U.S. Cl. 349/65

(57) ABSTRACT

A backlight unit in a liquid crystal display (“LCD”) device may prevent deformation of optical parts caused by moisture. A moisture prevention layer may be included on the front and/or rear surfaces of optical parts to insulate them from moisture which may cause deformations.

This application claims the benefit of the Korean Patent Application No. P06-0056493 filed on Jun. 22, 2006, which is hereby incorporated by reference.

### BACKGROUND

1. Technical Field

The present disclosure relates to a backlight unit that may prevent deformation of an optical part of a liquid crystal display.

2. Description of the Related Art

Liquid crystal display devices have experienced a trend towards lightness, thinness, low driving power consumption, etc. With this trend, the liquid crystal display devices are being used in office automation equipment, audio/video equipment, etc. The liquid crystal display devices may control the transmitted amount of light with a signal applied to control switches which may be arranged in a matrix shape, in order to display the desired picture on a screen. The liquid crystal display module may not be a self luminous display device, thereby requiring a separate light source such as a backlight unit.

The backlight unit is a direct type or an edge type depending on the location of a light source. The edge type backlight unit has a light source installed at the edge of one side of the liquid crystal display module, and irradiates an incident light from the light source to a liquid crystal display panel through a light guide panel and a plurality of optical sheets. The direct type backlight unit has a plurality of light sources disposed under the liquid crystal display device, and irradiates the incident light from the light sources to the liquid crystal display panel through a diffusion plate and a plurality of optical sheets.

In the liquid crystal display device, optical parts may be deformed due to moisture. As the result of the deformation, a stain may appear in the display picture. The optical parts increase the surface uniformity of the light irradiated from the backlight unit, and include the diffusion plate and the optical sheets for inducing the progress path of the light to an observer.

Referring to FIG. 1, the direct type backlight unit may result in a display quality defect in a picture display area of a liquid crystal display panel 14 due to a moisture evaporation rate difference between an upper surface and a lower surface of the diffusion plate 10. In the direct type backlight unit moisture is relatively evenly penetrated to a diffusion plate 10 and optical sheets 16 before the liquid crystal display module is driven. In other words, when a lamp 12 maintains an off-state, the moisture may be evenly distributed over the diffusion plate 10 and optical sheets 16.

FIG. 2 is a diagram representing an enlarged portion within the dotted circle from FIG. 1. As in FIG. 2, the diffusion plate 10 and the optical sheets 16 are deposited on the liquid crystal display panel 14. If the lamp 12 is turned on by driving the liquid crystal display module, the diffusion plate 10 has its temperature increased in the vicinity of the lamp 12 due to the heat generated by the lamp 12. Accordingly, the diffusion plate 10 may have a moisture evaporation rate of a lower surface facing the lamp 12 that is higher than the moisture evaporation rate of an upper surface. As a result, heat expansion may be affected by the heat generation of the lamp 12 and the resulting upper/lower surface moisture content difference of the diffusion plate 10. Accordingly, the diffusion plate 10 and the optical sheets 16 deposited thereon may become bent to become convex upward.

The amount of deformity of the diffusion plate 10 caused by the moisture difference and the heat expansion difference is greater than a gap between the diffusion plate 10 and the liquid crystal display panel. The diffusion plate 10 is in contact with the liquid crystal display panel so that if the amount of light irradiated to the liquid crystal display panel 14 becomes non-uniform, resulting in a stain on the display image.

The optical sheets 22 of the edge type backlight unit as shown in FIG. 3 are wrinkled in the vicinity of the lamp 20 as shown in a dotted line. A wrinkle deformity may be generated in the optical sheets 22 in the area around the lamp 20. The reason the deformity is near the area around the lamp 20 is due to the temperature and moisture evaporation rate difference in that area. The lamp 20 raises the temperature and becomes warm which in turn raise the temperature and moisture evaporation rate in that area. Accordingly, the temperature and moisture evaporation rate in the vicinity of the lamp 20 is higher than other areas. If the optical sheets 22 become wrinkled, the brightness of the display picture of the liquid crystal display panel may become non-uniform and a stain may appear.

In a liquid crystal display device, the optical parts such as the diffusion plate 10, the optical sheets 16, 22, etc may become deformed by a moisture difference, or a temperature difference, despite the presence of a backlight. As a result, the progress path of the light may be partially distorted and the surface uniformity of the light is decreased, thereby remarkably decreasing a display grade or display quality. Further, the optical parts, such as a polarizer, analyzer, viewing angle compensation film, being attached to the liquid crystal display panel are also easily deformed by moisture. Accordingly, a liquid crystal display device may benefit from a reduction in the temperature and moisture differences to reduce deformations.

### BRIEF SUMMARY

By way of introduction, the embodiments described below relate to a backlight unit that may be used in liquid crystal display and is adapted to prevent or reduce a deformation of an optical part caused by moisture.

In a first aspect, a backlight unit irradiates light to a liquid crystal display panel. The backlight unit includes a light source and an optical part coupled with the light source and the liquid crystal display panel. A moisture prevention layer is coupled with the optical part and formed on at least one of a front surface of the optical part or a rear surface of the optical part.

In a second aspect, a liquid crystal display device includes a liquid crystal display panel to which a first optical part is coupled with. A backlight unit includes a light source, and a second optical part which is coupled with the light source and the liquid crystal display panel. The backlight unit further includes a first moisture prevention layer formed in a front surface and a rear surface of the second optical part.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views.

FIG. 1 is a cross sectional diagram representing a liquid crystal display module with a direct type backlight unit of the related art;

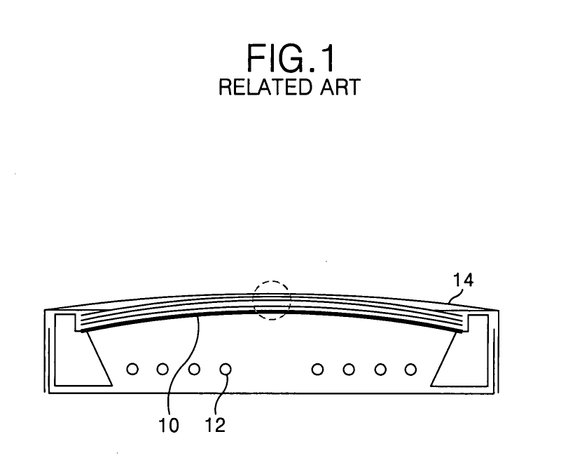

FIG. 2 is an diagram representing a dotted part in FIG. 1;

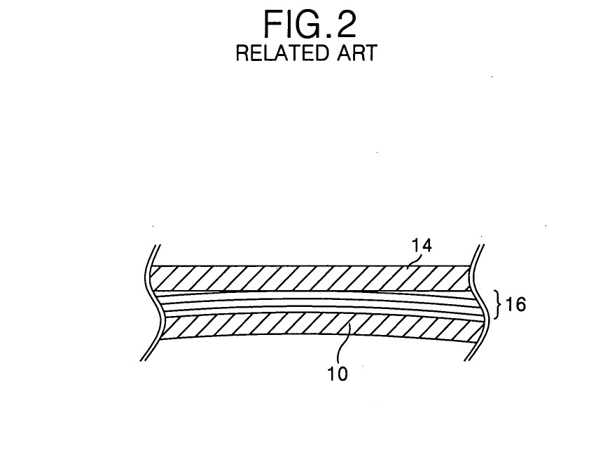

FIG. 3 is a cross sectional diagram representing an edge type backlight unit of the related art;

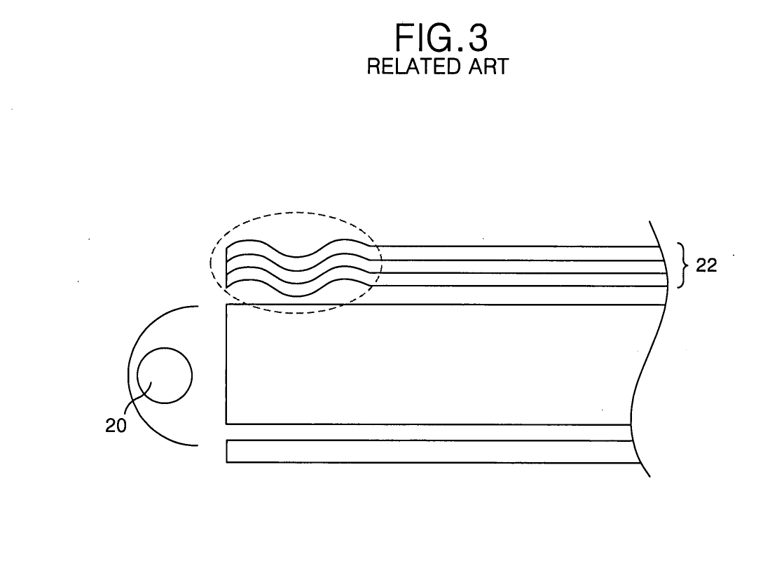

FIG. 4 is a cross sectional diagram representing an optical part according to one embodiment;

FIG. 5 is a graph representing a moisture absorption rate of the optical part shown in FIG. 4;

FIG. 6 is a cross sectional diagram representing a direct type backlight unit;

FIG. 7 is a cross sectional diagram representing a diffusion plate shown in FIG. 6;

FIG. 8 is a cross sectional diagram representing a diffusion sheet shown in FIG. 6;

FIG. 9 is a cross sectional diagram representing a prism sheet shown in FIG. 6; and

FIG. 10 is a cross sectional diagram representing an edge type backlight unit.

### DETAILED DESCRIPTION OF THE PREFERRED EMBODIMENT

The principles described herein may be embodied in many different forms. The embodiments relate to a system and method for a liquid crystal display that reduces moisture differentiation and/or deformation of the optical parts of the display. Reference will now be made in detail to the embodiments of the present disclosure, examples of which are illustrated in the accompanying drawings.

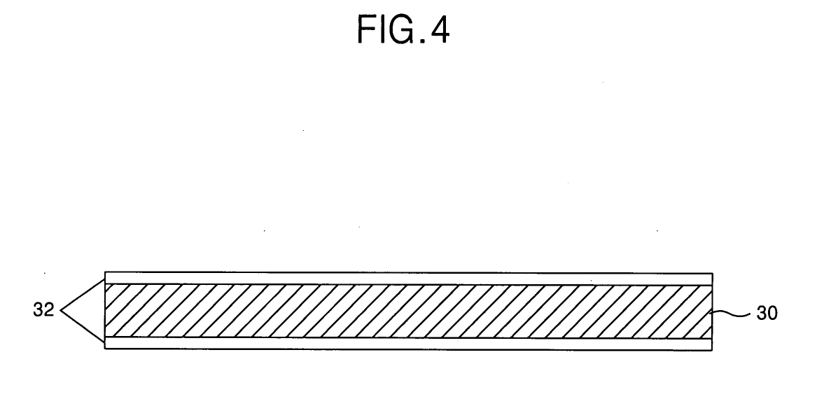

FIG. 4 is a cross sectional diagram representing an optical part according to one embodiment. An optical part 30 may have a moisture prevention layer 32 added to a front surface and a rear surface according to one embodiment. The moisture prevention layer 32 has a low moisture absorption rate and may be formed by a coating and/or laminating method.

The optical part 30 may be an optical part of a backlight unit such as a diffusion plate, a diffusion sheet, a prism sheet, etc. An optical part may be attached to the liquid crystal display panel such as an optical compensation film like a viewing angle compensation film, an analyzer and a polarizer. The optical part 30 is made of a material, where a deformity may be generated by moisture content or moisture differences, e.g., polymethylmethacrylate (“PMMA”), polyethylene terephthalate (“PET”), polycarbonate (“PC”), tri-acetyl-cellulose (“TAC”), etc.

The moisture prevention layer 32 may be configured to insulate the optical part 30 from moisture. Moisture may be diffuse wetness that can be felt as vapor in the atmosphere or condensed liquid on the surfaces of objects. The moisture prevention layer 32 may operate to reduce varying amounts of moisture from contacting the optical part 30. For example, there may still be some moisture in contact with the optical part 30, but the moisture prevention layer 32 substantially prevents moisture from contacting the optical part 30. Alternatively, the optical part 30 is not exposed to moisture because of the moisture prevention layer 32, which may act to prevent the deformity of the optical part 30 in a high temperature/high humidity environment. The moisture prevention layer 32 may be formed to a thickness of about 10˜50 μm in the front surface and/or the rear surface of the optical part 30. Also, a low moisture absorbing material may be used as the moisture prevention layer 32, such as a cyclo-olenfin-copolymer (“COC”), parylene, etc.

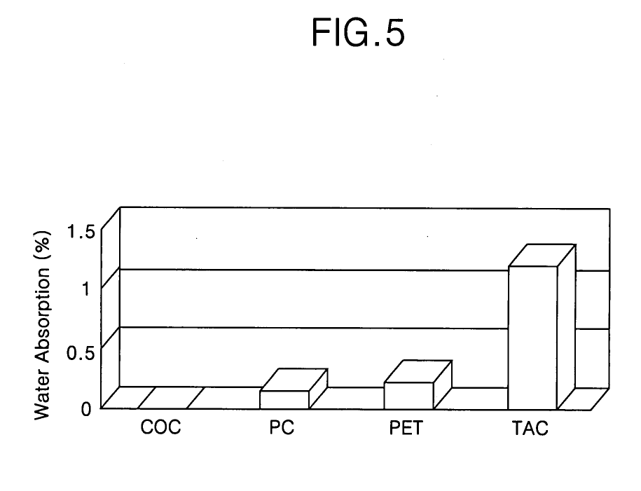

The moisture prevention layer 32 has a lower moisture absorption rate than the optical part material. This is shown in the graph of FIG. 5. Specifically, FIG. 5 shows the results from an experiment with ASTM D570 test mode. The ASTM D570 standard is a standard that the moisture content is measured after a sample is dipped in a solution of 23° C. for 24 hours. The COC which may be applied to the moisture prevention layer 32 has a lower moisture absorption rate than PC, PET, TAC. The moisture absorption rate of COC in the graph is about 0.01%, while the moisture absorption rate of TAC is about 1%. On the other hand, parylene which can be applied as the moisture prevention layer 32 has its moisture absorption rate being about 0.1% higher then COC, but the moisture absorption rate is lower than PMMA (0.67%), PC (0.25%).

The moisture prevention layer 32 operates to substantially prevent the optical part 30 from being exposed to the moisture even in the high humidity condition with a low moisture absorption rate. Accordingly, the moisture evaporation difference caused by the temperature distribution difference does not appear because the optical part 30 is not directly exposed to the moisture, thus the optical part 30 is may not be deformed by moisture.

The optical part 30 where the moisture prevention layer 32 is formed may be applied to the optical part of the backlight unit or the optical film of the liquid crystal display panel.

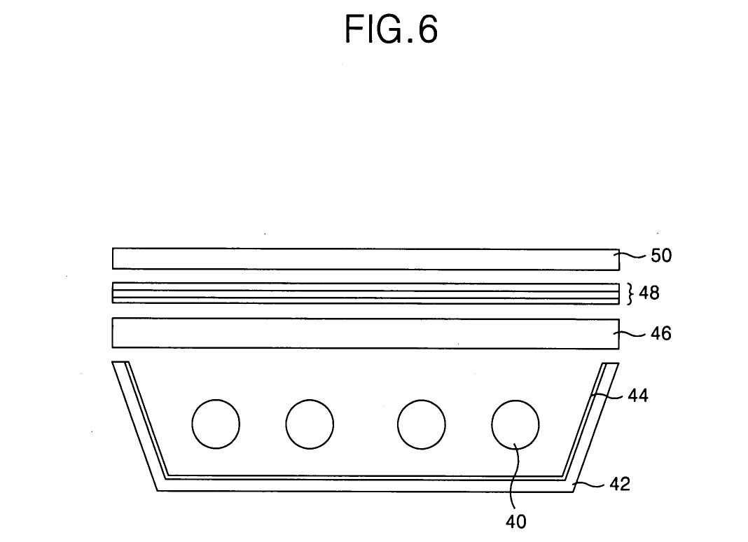

FIG. 6 is a cross sectional diagram representing a direct type backlight unit to which the optical part shown in FIG. 4 may be applied. FIG. 6 represents a liquid crystal display device adopting a direct type backlight unit according to one embodiment. The liquid crystal display device according to one embodiment includes a liquid crystal display panel 50; a plurality of lamps 40 which irradiate light under the liquid crystal display panel 50; a bottom cover 42 which houses the lamps 40 in an internal space thereof; a reflection plate 44 installed in the bottom surface inside the bottom cover 42; a diffusion plate 46 which shields an aperture surface of the bottom cover 42; and at least one or more optical sheets 48 which are deposited on the diffusion plate 46.

The liquid crystal display panel 50 may include a spacer (not shown) for fixedly keeping a gap between the upper substrate and the lower substrate, and a liquid crystal is injected between the lower substrate and the upper substrate. A color filter, a common electrode and a black matrix (not shown) are formed in the upper substrate of the liquid crystal display panel 50. Further, signal lines such as a data line and a gate line (not shown) are formed in the lower substrate of the liquid crystal display panel 50, and a thin film transistor (“TFT”) is formed at each crossing part of the data line and the gate line. The TFT switches a data signal, which is to be transmitted to a liquid crystal cell from the data line, in response to a scan signal (gate pulse) from the gate line. A pixel electrode is formed in a pixel area between the data line and the gate line. Further, a pad area connected to each of the data line and the gate line is formed in one side of the lower substrate, and a tape carrier package (not shown) where a drive IC for applying a drive signal to the TFT is mounted is attached to the pad area. The tape carrier package supplies the data signal from the driver IC to the data line, and supplies the scan signal to the gate line. The polarizer and the analyzer are attached to the upper substrate and the lower substrate of the liquid crystal display panel 50, and the optical compensation film such as the viewing angle compensation film may be attached thereto. The moisture prevention layer 32 may be formed in at least one surface of the optical part of the liquid crystal display panel 50 to prevent direct moisture exposure.

The lamps 40 are light sources and include a cold cathode fluorescent lamp (“CCFL”) or an external electrode fluorescent lamp (“EEFL”). A light emitting diode LED can replace the lamps 40 as another light source other than the lamps 40.

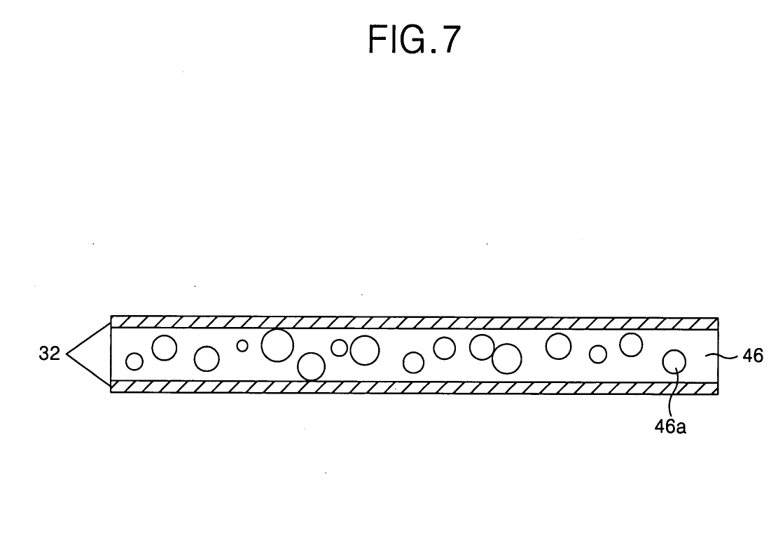

The diffusion plate 46 diffuses the incident light from the lamps 40 to irradiate the light to the liquid crystal display panel 50, and prevent a bright line caused by the lamps 40 from appearing in the display picture by increasing the surface uniformity of the light. The diffusion plate 46 includes a plurality of beads 46a mixed into polymethylmethacrylate (“PMMA”), as shown in FIG. 7. The beads 46a disperse the light incident from the lamps 40. The moisture prevention layer 32 is formed in the front and/or rear surfaces of the diffusion plate 46, and the moisture prevention layer 32 prevents the deformity of the diffusion plate 46 by preventing the diffusion plate 46 from being exposed directly or substantially to moisture.

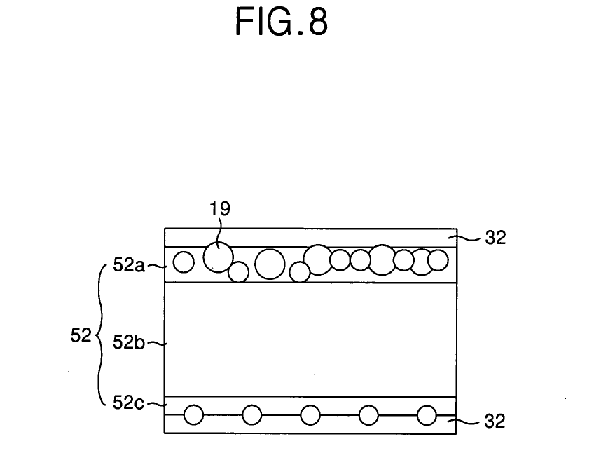

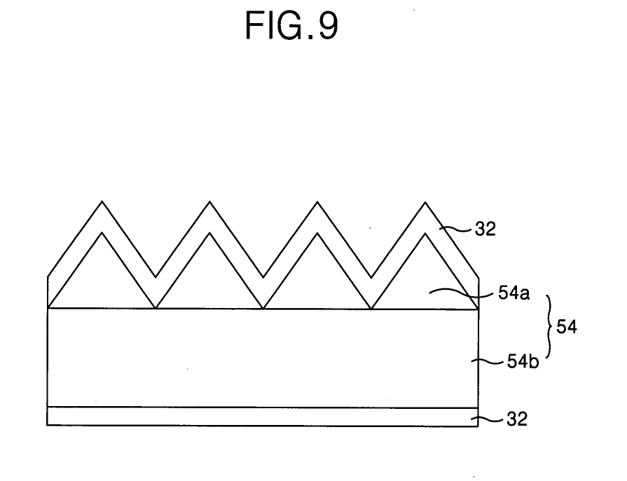

FIG. 8 is a cross sectional diagram representing a diffusion sheet shown in FIG. 6. The optical sheets 48 (as in FIG. 6) include a diffusion sheet 52 which diffuses the light incident through the diffusion plate 46 as shown in FIG. 8. The optical sheets 48 may also include a prism sheet 54 which bends the progress path of the light to be vertical to the display surface, as in FIG. 9. The moisture prevention layer 32 is formed on at least one surface of the front and/or rear surfaces of the optical sheets 48.

The diffusion sheet 52, as in FIG. 8, includes a transparent base film 52b; a diffusion layer 52a which is coated on the base film 52b to diffuse the light; and an anti-blocking layer 52c which is coated under the base film 52b to protect the diffusion sheet 52. Herein, the base film 52b may be made of a polyethylene PE group, e.g., PET. The moisture prevention layer 32 is formed on the front and/or rear surfaces of the diffusion sheet 52, and the moisture prevention layer 32 prevents the diffusion sheet 32 from being deformed by the moisture.

FIG. 9 is a cross sectional diagram representing a prism sheet shown in FIG. 6. The prism sheet 54, as shown in FIG. 9, includes a base film 54b; and a plurality of prisms 54a formed on the base film 54b. Herein the base film 54b is made of a PE group, e.g., PET. The moisture prevention layer 32 is formed in the front and/or rear surfaces of the prism sheet 54, and the moisture prevention layer 32 prevents the prism sheet 54 from being deformed by the moisture. The diffusion sheet 52 and the prism sheet 54 where the moisture prevention layer 32 is formed are not affected by the moisture, thus no deformity is generated by the moisture. Accordingly, the wrinkle phenomenon generated around the lamp 40 may be prevented.

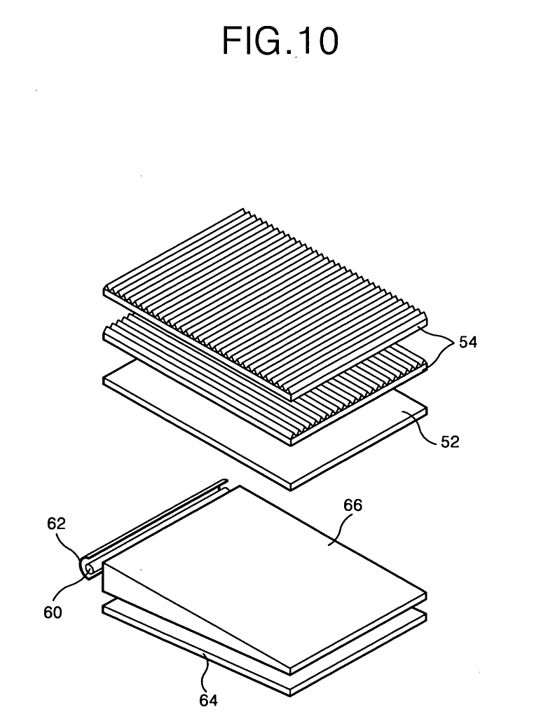

FIG. 10 is a cross sectional diagram representing an edge type backlight unit to which the optical part shown in FIG. 4 is applied. FIG. 10 represents a liquid crystal display device adopting an edge type backlight unit according to one embodiment. The liquid crystal display panel is not shown in FIG. 10.

Referring to FIG. 10, the edge type backlight unit includes a lamp 60 which generates light; a lamp housing 62 installed to encompass the lamp 60; a light guide panel 66 which converts the incident light from the lamp 60 into a surface light; a reflection plate 64 installed in the rear surface of the light guide panel 66; and a diffusion sheet 52 and a prism sheet 54 which are sequentially deposited on the light guide panel 66 and each may have a moisture prevention layer. Optical parts with a moisture prevention layer 32 can be attached to the liquid crystal display panel which may be disposed on the prism sheets 54.

In the edge type backlight unit, the light generated in the lamp 60 is incident to the light guide panel 66 through an incidence surface which exists on the side of the light guide panel 66. The lamp housing 62 has a reflection surface inside to reflect the light from the lamp 60 to the incidence surface of the light guide panel 66. The light guide panel 66 is made in a shape of having an inclined rear surface and a horizontal front surface, and is not easily deformed or broken because its strength is high. The light guide panel 66 may be formed of polymethylmethacrylate (“PMMA”) which has a good transmittance. The reflection plate 64 reflects the light incident to itself through the rear surface of the light guide panel 66 again to the light guide panel 66, thereby acting to reduce the light loss.

The moisture prevention layer is formed on one or both sides of the diffusion sheet 52 and the prism sheet 54 by the coating and/or laminating method. The moisture prevention layer is configured to prevent the diffusion sheet 52 and the prism sheet 54 from being deformed by the moisture.

As described above, the backlight unit and the liquid crystal display device using the same according to the present embodiments forms the moisture prevention layer in the optical part, which is applied to the backlight unit or the liquid crystal display panel, i.e., the diffusion plate, the diffusion sheet, the prism sheet, the polarizer, the analyzer, the viewing angle compensation film, etc. Accordingly, the present embodiments prevents the optical part from being exposed directly to the moisture, thereby preventing the deformity of the optical part. Accordingly, the present embodiments may not only prevent the deformity of the optical plate, but can also improve the display quality of the liquid crystal display panel.

Although the present embodiments have been explained by the embodiments shown in the drawings described above, it should be understood to the ordinary skilled person in the art that the invention is not limited to the embodiments as described herein, but rather that various changes or modifications thereof are possible without departing from the spirit of the invention. Accordingly, the scope of the invention shall be determined only by the appended claims and their equivalents.

What is claimed is:

1. A backlight unit which irradiates light to a liquid crystal display panel, comprising:
a light source;
an optical part coupled with the light source and the liquid crystal display panel; and
a moisture prevention layer coupled with the optical part and disposed on at least one of a front surface of the optical part or a rear surface of the optical part.

2. The backlight unit according to claim 1, wherein the moisture prevention layer includes at least one of a cyclo olenfin copolymer (“COC”), or parylene.

3. The backlight unit according to claim 2, wherein the thickness of the moisture prevention layer is about 10 μm˜50 μm.

4. The backlight unit according to claim 1, wherein the light source comprises a plurality of light sources which are disposed under the liquid crystal display panel.

5. The backlight unit according to claim 4, wherein the optical part comprises:
a diffusion plate coupled with the light source to be separated from the light source in a designated height; and
a diffusion sheet and a prism sheet which are coupled with the diffusion plate.

6. The backlight unit according to claim 1, further comprising:
a light guide panel coupled between the light source and the liquid crystal display panel,
wherein the light source faces a side surface of the light guide panel.

7. The backlight unit according to claim 6, wherein the optical part comprises:
a diffusion sheet and a prism sheet coupled with the light guide panel.

8. A liquid crystal display device comprising:
a liquid crystal display panel to which a first optical part is coupled with; and
a backlight unit comprising a light source, a second optical part which is coupled with the light source and the liquid crystal display panel, and a first moisture prevention layer disposed on a front surface and a rear surface of the second optical part.

9. The liquid crystal display device according to claim 8, further comprising:
a second moisture prevention layer disposed on at least one surface of the first optical part.

10. The liquid crystal display device according to claim 8, wherein the first moisture prevention layer includes at least one of cyclo olenfin copolymer (“COC”) or parylene.

11. The liquid crystal display device according to claim 9, wherein the second moisture prevention layer includes any one of COC cyclo olenfin copolymer (“COC”) or parylene.

12. The liquid crystal display device according to claim 10, wherein the thickness of the first moisture prevention layer is about 10 μm˜50 μm.

13. The liquid crystal display device according to claim 11, wherein the thickness of the second moisture prevention layer is about 10 μm˜50 μm.

14. The liquid crystal display device according to claim 8, wherein the light source comprises a plurality of the light sources which are disposed under the liquid crystal display panel.

15. The liquid crystal display device according to claim 8, wherein the backlight unit further comprises a light guide panel coupled with the light source and the liquid crystal display panel, and the light source faces a side surface of the light guide panel.
